(19) United States
(12) Patent Application Publication
(10) Pub. No.: US 2006/0294356 A1
(43) Pub. Date: Dec. 28, 2006

(54) Apparatus and method of an executable-in-place flash device

(75) Inventors: Santosh Kumar, San Jose, CA (US); Soummya Mallick, Fremont, CA (US); Krishnakumar Mani, San Jose, CA (US); Venkat Raman, Saratoga, CA (US)

Correspondence Address: SANTOSH KUMAR, 4124 LITTLEWORTH WAY, SAN JOSE, CA, 95135, US

(73) Assignee: xipkey, Inc.

(21) Appl. No.: 11/168,757

(22) Filed: Jun. 27, 2005

(51) Int. Cl. G06F 9/00

(52) U.S. Cl. 713/2

(57) ABSTRACT

Apparatuses and methods of an executable-in-place solid-state device are disclosed. In one embodiment, a solid-state device includes a flash memory coupled to a dynamic random access memory, the dynamic random access memory to store at least as much data as the flash memory; and a logic circuit coupled to the flash memory and the dynamic access memory to copy data from the flash memory to the dynamic random access memory on power up of a data processing system coupled to the solid-state device. The logic circuit is to minimize writes to the flash memory by using the dynamic access memory as a working memory during operation of the data processing system, and/or to block at least some sectors of at least one of the flash memory and the dynamic random access memory when the data processing system uses the working memory to conserve power usage of the solid-state device.

### FIELD OF TECHNOLOGY

This disclosure relates generally to the technical fields of solid-state devices, flash devices, random access memory devices, and in one example embodiment, to an apparatus and method of an executable-in-place flash device.

### BACKGROUND

A flash memory is a form of rewritable memory device that, unlike a Random Access Memory device, holds its content without requiring connection to a power supply. The flash memory is made in two forms: a NOR-type flash memory and a NAND-type flash memory. The NAND-type flash memory has faster erase and write times, higher density, and lower cost per-bit than the NOR-type flash memory, and ten times the endurance. This makes the NAND-type flash memory suitable for mass-storage devices such as PC cards and various memory cards.

A flash drive (e.g., a type of solid-state device) is essentially the NAND-type flash memory integrated with an interface (e.g., USB) and used as a small, lightweight, removable data storage device. The flash drive is also known as “a pen drive”, “a thumb drive”, “a flash device”, “an USB key”, “an USB memory key”, “a USB stick”, “a jump drive”, “a keydrive” and many more names. The flash drive may be active only when powered by a USB computer connection, and may require no other external power source or battery power source (e.g., may run off a limited supply afforded by a USB interface). To access data stored in the flash drive, the flash drive can be connected to a computer, either by a direct connection to the computer's USB port or via a USB hub.

The flash drive is resistant to scratches and dust that plagued previous forms of storage like hard drives, compact discs, and floppy disks. Furthermore, the flash drive may be up to 1,000 times faster than hard drives (e.g., according to current speeds, in the future may be different), compact discs, and floppy disks. The solid-state design of the flash drive means that it may survive some accidents (e.g., impacts, being dropped or crushed, run through a washing machine, or even possibly being dropped in coffee). This makes the flash drive ideal for transporting personal data and/or work files from one location to another (such as from home to school or office) and/or for carrying around personal data that the user typically wants to access in a variety of places.

The flash drive may consist of a small printed circuit board encased with a robust plastic casing, making the drive sturdy enough to be carried around in a pocket, as a keyfob (e.g., a decorative item which many people carry with their keys, on a ring or a chain, often to provide a better grip or to simply make a personal statement), or on a lanyard (e.g., a rope or cord often worn around the neck or wrist to carry something). A USB (type ‘A’ USB or mini-USB) connector may protrude from a plastic protection encompassing the flash drive and may be covered by a removable plastic cap.

The flash drive however can sustain only a limited number of write/erase cycles before failure. This limits the ability of the flash drive execute in place (e.g., to run application software such Microsoft® Word®, Microsoft® Excel®, Adobe® Photoshop®, etc. requiring numerous read/write sequences during operation). In addition, this limits the flash drive from running many popular operating systems (e.g., Microsoft® Windows®, or Apple® MacOS®) typically operable on the hard drive. Some developers have produced customized versions of less-popular operating systems (e.g., Linux) or applications (e.g., Mozilla Firefox) designed to run from flash drives. This requires that application developers create specialized versions of their software which can be a technically challenging, expensive, time consuming, and inefficient process.

### SUMMARY

Apparatuses and methods of an executable-in-place solid-state device are disclosed. In one aspect, a solid-state device includes a flash memory coupled (e.g., connected) to a dynamic random access memory that can store at least as much data as the flash memory. In this one aspect, a logic circuit is coupled to the flash memory and the dynamic access memory and copies data from the flash memory to the dynamic random access memory on power up of a data processing system coupled to the solid-state device. As such, application programs may be executable directly from the solid-state device without customized optimization for the flash memory.

The solid-state device may be a portable device external to the data processing system (e.g. a keyfob and a lanyard) and may be packaged to withstand heat at least until 125 degrees Celsius. In addition, the solid-state device may have a mean time between failures of 3 million hours. The solid-state device may be coupled to the data processing system through a USB connector.

A liquid crystal display may be provided to indicate that the solid-state device is operable when data of the flash memory is copied to the dynamic random access memory. The dynamic random access memory may be used as a working memory during operation of the data processing system, and data may be written back to the flash memory when power is no longer received by the solid-state device. The logic circuit may also block at least some sectors of the flash memory and/or the dynamic random access memory (e.g., inside the solid state device) when the data processing system uses the working memory to conserve power usage of the solid-state device. The logic circuit may also transfer all (or a substantial part) of the data in the dynamic random access memory to the flash memory on power down of the data processing system.

The solid-state device may further include a driver (e.g., the driver may be in data processing system) to instruct the data processing system to boot up from an operating system installed on the solid-state device and when the solid-state device is connected to the data processing system. The driver may be automatically loaded on the data processing system as well (e.g., through an autoexec application that automatically loads when the solid-state device is coupled to the data processing system).

The logic circuit may copy sectors from the flash memory in an order based on a prior history of data access by the data processing system and/or may include a capacitor which supplies power to retain at least some data of the flash device in the dynamic random access memory upon power down of the data processing system.

In another aspect, a method includes copying sectors of a flash memory of a solid-state device to a dynamic random access memory of the solid-state device when the solid-state device receives power through an interface; manipulating sectors of the dynamic random access memory based on commands received from a data processing system; and copying manipulated sectors of the dynamic random access memory back to the flash memory when power through the interface is no longer received.

The dynamic random access memory is to hold at least as much data as the flash memory, and may include an interface that is a universal serial bus interface, a secure flash interface, a secure digital interface, and/or a compact flash interface.

The sectors may be copied to and from the flash memory in a predetermined order based on a prior history of access by the data processing system. The data processing system may begin manipulating the data of the dynamic random access memory before all the sectors are copied from the flash memory to the dynamic random access memory. The manipulation may include a write, a read, a delete, and/or a modify function to at least one sector of the dynamic random access memory.

In yet another aspect, a machine readable method of a data processing system includes providing power to an executable-in-place portable flash device external to the data processing system through a USB interface; redirecting a boot process of the data processing system to the flash device based on a driver installed in a storage device of the data processing system; and executing at least one application on a proxy memory of the executable-in-place portable flash device. In this yet another aspect, the proxy memory is at least as large as a flash memory of the executable-in-place portable flash device and may contain a mirror image of the data of the flash memory.

Other features of various embodiments will be apparent from the accompanying drawings and from the detailed description that follows.

### BRIEF DESCRIPTION OF THE DRAWINGS

Embodiments of the present invention is illustrated by way of example and not limitation in the figures of the accompanying drawings, in which like references indicate similar elements and in which:

FIG. 1 is a system view of an executable-in-place solid-state device coupled to a data processing system, according to one embodiment.

FIG. 2 is a block diagram of the executable-in-place solid-state device of FIG. 1 having a flash memory, a dynamic random access memory, a custom circuit, a memory controller, and an interface according to one embodiment.

FIG. 3 is a logic circuit view of the custom circuit of FIG. 3 having a command arbitrator circuit, a load register circuit, an output register circuit, according to one embodiment.

FIG. 4 is a process view of the application specific integrated circuit, according to one embodiment.

FIG. 5 is a process view of the data processing system coupled to the executable-in-place solid-state device, according to one embodiment.

FIG. 6 is a diagrammatic representation of a machine in the example form of a computer system in which there are a set of instructions, for causing the machine to perform any one or more of the methodologies discussed herein may be executed, according to one embodiment.

FIG. 7 is a process flow of a method of manufacture of the executable-in-place solid-state device of FIG. 1, according to one embodiment.

Other features of the present embodiments will be apparent from the accompanying drawings and from the detailed description that follows.

### DETAILED DESCRIPTION

Apparatuses and methods of an executable-in-place solid-state device are disclosed. In the following description, for purposes of explanation, numerous specific details are set forth in order to provide a thorough understanding of the various embodiments. It will be evident, however, to one skilled in the art that the various embodiments may be practiced without these specific details. It is to be understood that other embodiments may be utilized and that changes may be made without departing from the scope of the various embodiments. The following detailed description is, therefore, not to be taken in a limiting sense, and the scope of the present invention is defined only by the appended claims.

According to an embodiment, there is provided a solid-state device that includes a flash memory coupled to a dynamic random access memory, the dynamic random access memory to store at least as much data as the flash memory, and a logic circuit coupled to the flash memory and the dynamic access memory to copy data from the flash memory to the dynamic random access memory on power up of a data processing system coupled to the solid-state device.

In addition, in another embodiment, a method may include copying sectors of a flash memory of a solid-state device to a dynamic random access memory of the solid-state device when the solid-state device receives power through an interface, manipulating sectors of the dynamic random access memory based on commands received from a data processing system, and copying manipulated sectors of the dynamic random access memory back to the flash memory when power through the interface is no longer received.

It will be appreciated that the various embodiments discussed herein may/may not be the same embodiment, and may be grouped into various other embodiments not explicitly disclosed herein.

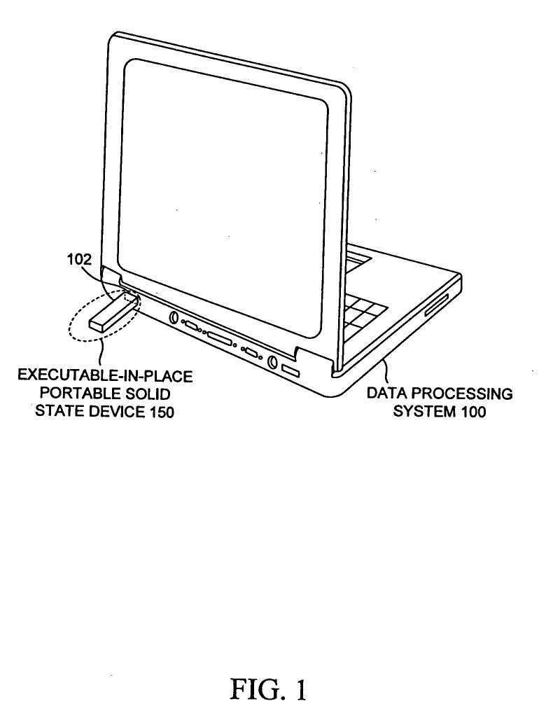

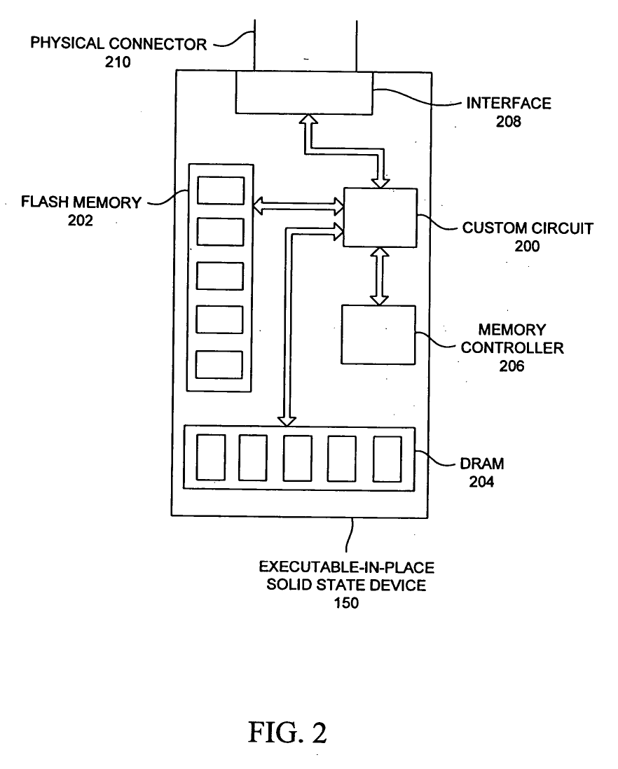

FIG. 1 is a system view of an executable-in-place solid-state device 150 coupled to a data processing system 100, according to one embodiment. In FIG. 1, the data processing system 100 (e.g., a laptop computer, a desktop computer, etc.) is coupled (e.g., connected) to an executable-in-place solid-state device 150. The executable-in-place solid-state device 150 is “executable-in-place” (e.g., able to run application software such a Microsoft® Word®, Microsoft® Excel®, Adobe® Photoshop®, etc. requiring numerous read/write sequences during operation) partly because it includes a dynamic random access memory 204 that is at least as large as a flash memory 202 as illustrated in the exploded view of the executable-in-place solid-state device 150 in FIG. 2. The executable-in-place solid-state device 150, may be external to the data processing system 100, and may hold data without requiring connection to a power supply. A connector 102 (e.g. a USB port/hub, etc.) may be used to connect the executable-in-place solid-state device 150 to the data processing system 100.

The executable-in-place solid-state device 150 is portable in that it may be small enough to be carried around in an adult pocket (e.g., approximately 6 inches by 6 inches or smaller) and designed as a keyfob and/or as a lanyard. The executable-in-place solid-state device 150 is a solid-state device in that it may not include a spinning disk (e.g., as found in a hard drive). Furthermore, in one embodiment, the executable-in-place solid-state device 150 may be capable of withstanding shocks up to 3 g or more, such as may be caused if the executable-in-place solid-state device 150 is dropped from an elevated position (e.g., such as a 5 story building). In one embodiment, the executable-in-place solid-state device 150 is optimized to withstand drops of up to 10 feet in height or more. In addition, according to one embodiment, the executable-in-place solid-state device 150, may be packaged to withstand heat at least until 125 degrees Celsius, and may have a mean time between failures of 3 million hours or more.

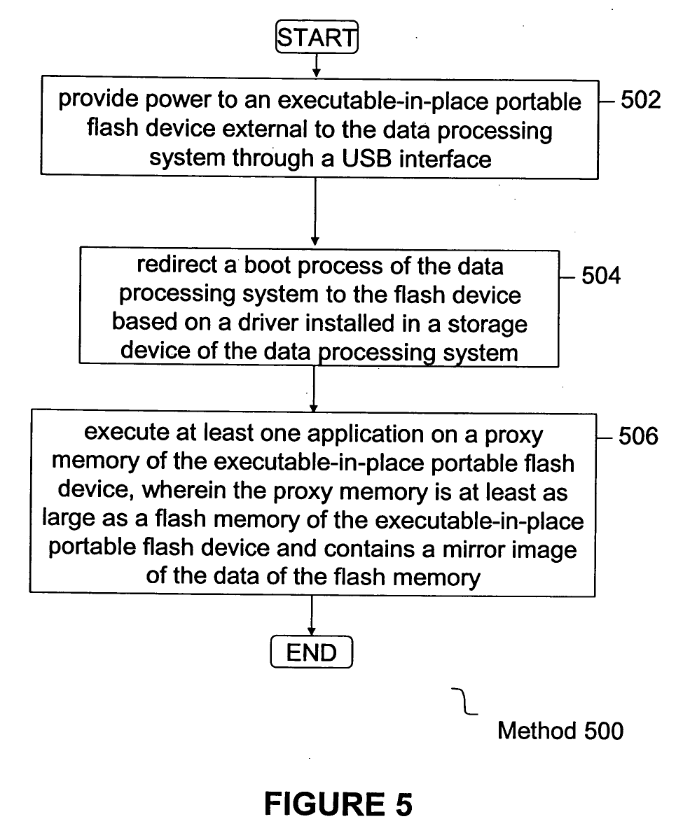

The executable-in-place solid-state device 150 may further include a driver (e.g., executed by the data processing system 100) to instruct the data processing system 100 to boot up from an operating system (e.g., Microsoft® Windows®) installed on the executable-in-place solid-state device 150. The driver may be automatically loaded on the data processing system 100 (e.g., through an autoexec program that runs whenever the data processing system 100 detects that it is connected to the executable-in-place solid-state device 150) when the executable-in-place solid-state device 150 is connected to the data processing system 100 (e.g. as later will described in detail in FIG. 5). In addition, the solid-state device 150 may execute application programs directly without customized optimization for the flash memory 202 and without affecting the life of the flash memory 202 in the executable-in-place solid-state device 150 as illustrated in FIG. 2 (e.g., because the application programs may be executed from the dynamic random access memory 204 of FIG. 2 having a mirror image of the data of the flash memory 202, and because the dynamic random access memory 204 of FIG. 2 may have a larger capacity for reads/writes than the flash memory 202).

FIG. 2 is a block diagram of the executable-in-place solid-state device 150 of FIG. 1 having the flash memory 202, the dynamic random access memory 204, a custom circuit 200, a memory controller 206, and an interface 208 according to one embodiment. In FIG. 2, the executable-in-place solid-state device 150 includes the flash memory 202 coupled to the dynamic random access memory 204 through the custom circuit 200. Also illustrated in FIG. 2, the memory controller 206 is connected to the custom circuit 200 to arbitrate and/or transfer data between the flash memory 202, the dynamic random access memory 204, other memory in the executable-in-place solid-state device 150 (e.g., not shown but a cache memory, a hard drive, etc.), and/or storage in the data processing system 100. In addition, an interface 208 (e.g., a USB interface), connects the executable-in-place solid-state device 150 to the data processing system 100 of FIG. 1. In one embodiment, the dynamic random access memory 204 stores at least as much data as the flash memory 202 (e.g., to enable the entire contents of the flash memory 202 to be transferred to the dynamic random access memory 204). Using the custom circuit 200, the executable-in-place solid-state device 150 may copy data from the flash memory 202 to the dynamic random access memory 204 when the executable-in-place solid-state device 150 receives power (e.g., may receive power though the interface 208 from the data processing system 100 coupled to the solid-state device 150 through the connector 102 as illustrated in FIG. 1). Similarly, when the executable-in-place solid-state device 150 no longer receives power, the custom circuit 200 may copy data from the dynamic random access memory 204 to the flash memory 202 of the executable-in-place solid-state device 150. The custom circuit 200 may minimize the writes to the flash memory 202 by using the dynamic access memory 204 as a working memory (e.g., a proxy memory) during operation of the data processing system 100 of FIG. 1. The custom circuit 200 may also transfer all data (or a substantial part) of the dynamic random access memory 204 to the flash memory 202 on power down of the data processing system 100. The memory controller 206 may regulate movement of data from the flash memory 202 to the dynamic random access memory 204 (e.g., shutting down at least some portions of the flash memory 202 to conserve power, parity checking, etc.). The memory controller 206 may also maintain a map (e.g., a table) of which blocks are being used by a particular application, and may shut down at least some of the blocks that are not being used by the particular application (e.g., not used for a particular amount of time, etc.).

In one embodiment, the custom circuit 200 disables at least some sectors of the flash memory 202 and/or the dynamic random access memory 204 when the executable-in-place solid-state device 150 is in operation (e.g., to conserve power). The solid-state device 150 can be connected to the data processing system through a physical connector 210 (e.g., a USB plug). The custom circuit 200 may receive power from the data processing system 100 of FIG. 1 through the interface 208 (e.g., when the physical connector 210 is connected to the connector 102). The executable-in-place solid-state device 150 may have a liquid crystal display (not shown) that provides an indication whether the data of the flash memory 202 has been transferred to the dynamic random access memory 204 in one embodiment.

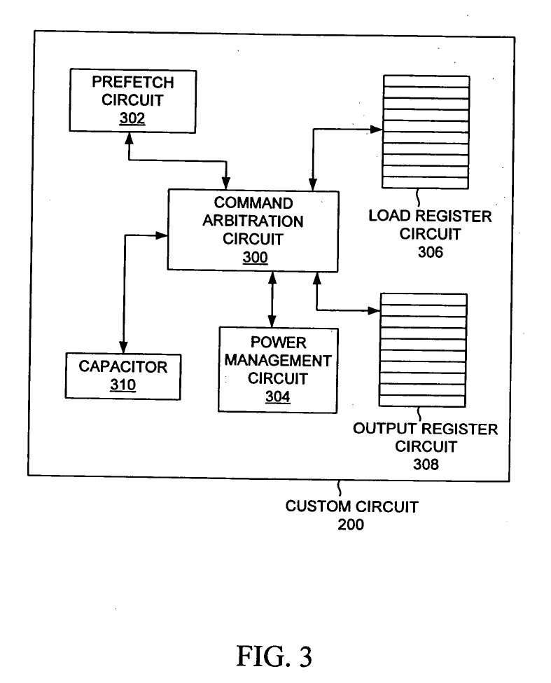

FIG. 3 is a logic circuit view of the custom circuit 200 of FIG. 2 having a pre-fetch circuit 302, a power management circuit 304, a load register circuit 306, an output register circuit 308, and a capacitor 310 coupled (e.g., connected) to a command arbitration circuit 300. The pre-fetch circuit 302 (e.g., a CMOS based logic circuit) may enable the executable-in-place solid-state device 150 to transfer of the contents of the flash memory 202 to the dynamic random access memory 204 during the boot up operation. The pre-fetch circuit 302 may increase the speed of a booting operation by loading data blocks in a particular order (e.g., preset by a user of the data processing system 100) from the flash memory 202 to the dynamic random access memory 204 when power is received by the executable-in-place solid-state device 150. For example, the pre-fetch circuit 302 may first load data blocks corresponding to a boot process, so that the executable-in-place solid-state device 150 can boot up the data processing system 100 without extra delay (e.g., by prioritizing transfer of data corresponding to a boot process to be copied first from the flash memory 202 to the dynamic random access memory 204 when power is received by the executable-in-place solid-state device 150). According to an embodiment, the pre-fetch circuit 302 (e.g., inside the custom circuit 200) may copy sectors from the flash memory 202 (e.g., as illustrated in FIG. 2) in an order based on a prior history of data access by the data processing system 100 of FIG. 1.

The command arbitrator circuit 300 may regulate copying of data between the flash memory 202 and the dynamic random access memory 204 of FIG. 2. The capacitor 310 of FIG. 3 may retain at least some data of the flash memory 202 of FIG. 2 (e.g., a non-volatile device that retains data even without power) in the dynamic random access memory 204 (e.g., a volatile device that loses data when power is no longer received). The capacitor 310 can serve as a means to prevent data from having to be recopied from the flash memory 202 to the dynamic random access memory 204 when power is temporarily (e.g., for 5 minutes, and/or 1 day) is unavailable to the executable-in-place solid-state device 150.

The load register circuit 306 and/or the output register circuit 308 may be used by the pre-fetch circuit 302 to temporarily store information that needs to be copied to/from the flash memory 202 and the dynamic random access memory 204. In addition, the load register circuit 306 may be used by the capacitor 310 to temporarily store information that needs to be retained by the dynamic random access memory 204 as long as possible (e.g., to allow for quick restart, to allow for quick boot-up, etc.). In addition, the load register circuit 306 and/or the output register circuit 308 may be used by the command arbitration circuit 300 and/or the power management circuit 304 to temporarily buffer data that needs to be transferred between the flash memory 202, the dynamic random access memory 204, and/or the data processing system 100.

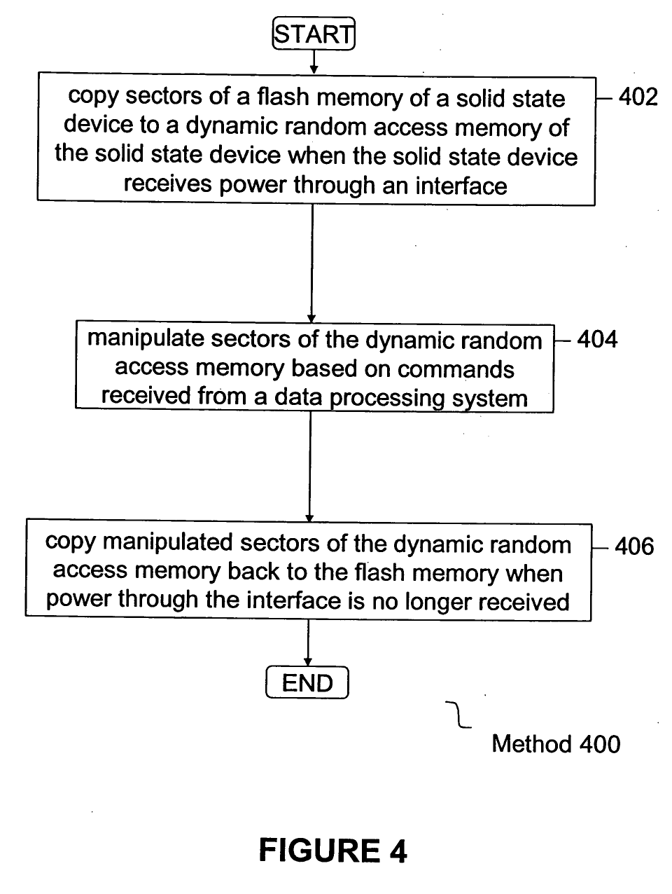

FIG. 4 is a process view of a method 400 of custom circuit 200, according to one embodiment. In operation 402, sectors of a flash memory (e.g., the flash memory 202 of FIG. 2) of a solid-state device (e.g., the executable-in-place solid-state device 150) may be copied to a dynamic random access memory (e.g., the dynamic random access memory 204) of the solid-state device (e.g., the executable-in-place solid-state device 150) when the solid-state device (e.g., the executable-in-place solid-state device 150) receives power through an interface (e.g., the interface 208).

In one embodiment, the dynamic random access memory (e.g., the dynamic random access memory 204) holds at least as much data as the flash memory (e.g., the flash memory 202) so that the dynamic random access memory (e.g., the dynamic random access memory 204) can be used as a working memory (e.g., a proxy memory) and writes to the flash memory (e.g., the flash memory 202) can be minimized (e.g., the number of write commands on the flash memory 202 may be limited by physical characteristics of the flash memory 202). Instead of continual read/writes, only operations of startup/shutdown may be required of the flash memory (e.g., the flash memory 202) when power status is changed (e.g., power received/no longer received) in one embodiment.

In operation 404, sectors of the dynamic random access memory (e.g., the dynamic random access memory 204) may be manipulated (e.g., copied, written to, deleted, modified, etc.) based on commands received from a data processing system (e.g., the data processing system 100). In one embodiment, the solid-state device (e.g., the executable-in-place solid-state device 150) is a portable device external to the data processing system (e.g., the data processing system 100 of FIG. 1). The solid-state device (e.g., the executable-in-place solid-state device 150) may be modeled in the form of a keyfob (e.g., a decorative item which many people carry with their keys, on a ring or a chain, often to provide a better grip or to simply make a personal statement), and/or as a lanyard (e.g., a rope or cord often worn around the neck or wrist to carry something).

In operation 406, manipulated sectors of the dynamic random access memory (e.g., the dynamic random access memory 204) may be copied back to the flash memory (e.g., the flash memory 202) when power through the interface (e.g., the interface 208) is no longer received. In one embodiment, the interface may be a universal serial bus interface, a secure flash interface, a secure digital interface, and/or a compact flash interface, etc. In one embodiment, the sectors may be copied to and from the flash memory in a predetermined order based on a prior history of access by the data processing system (e.g., the data processing system 100). The data processing system (e.g., the data processing system 100) may manipulate the data of the dynamic random access memory (e.g., the dynamic random access memory 204) before all the sectors are copied from the flash memory (e.g., the flash memory 202) to the dynamic random access memory (e.g., the dynamic random access memory 204) to minimize boot-up time.

FIG. 5 is a process view of a method 500 of the data processing system (e.g., the data processing system 100) coupled to the executable-in-place portable flash device (e.g., the executable-in-place solid-state device 150), according to one embodiment. In operation 502, power is provided to the executable-in-place portable flash device external to the data processing system 100 through a USB interface (e.g., the interface 208). In operation 504, a boot process of the data processing system 100 is redirected to the flash device (e.g., the executable-in-place solid-state device 150) based on a driver installed in a storage device (e.g., a hard drive inside the data processing system 100) of the data processing system 100. In operation 506, at least one application may be executed (e.g., run) on a proxy memory (e.g., the dynamic random access memory 204 of FIG. 2) of the executable-in-place portable flash device (e.g., the executable-in-place solid-state device 150) that is at least as large as a flash memory (e.g., the flash memory 202) of the executable-in-place flash device (e.g., the executable-in-place solid-state device 150) and the proxy memory may contain a mirror image of the data of the flash memory (e.g., the flash memory 202).

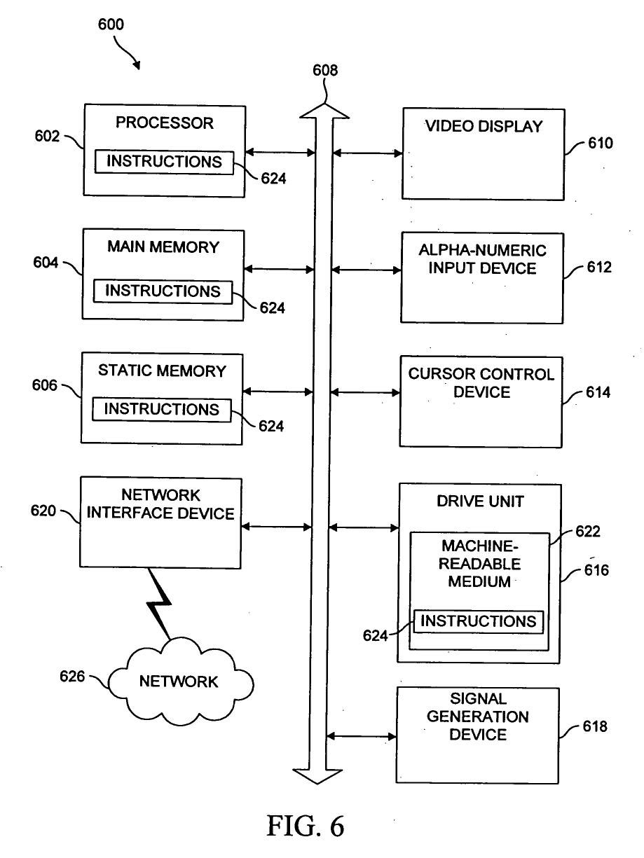

FIG. 6 shows a diagrammatic representation of machine in the computer system 600 (e.g., a laptop computer, the data processing system 100 of FIG. 1, etc.) within which a set of instructions, for causing the machine to perform any one or more of the methodologies discussed herein, may be executed. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment. The machine may be a personal computer (PC), a tablet PC, a laptop computer, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The computer system 600 includes a processor 602 (e.g., a central processing unit (CPU) a graphics processing unit (GPU) and/or both), a main memory 604 and a static memory 606, which communicate with each other via a bus 608. The computer system 600 may further include a video display unit 610 (e.g., a liquid crystal display (LCD) and/or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 (e.g., a hard drive) includes a machine-readable medium 622 on which is stored one or more sets of instructions (e.g., software 624) embodying any one or more of the methodologies and/or functions described herein. The software 624 may also reside, completely and/or at least partially, within the main memory 604 and/or within the processor 602 during execution thereof by the computer system 600, the main memory 604 and the processor 602 also constituting machine-readable media. The software 624 may further be transmitted and/or received over a network 626 via the network interface device 620.

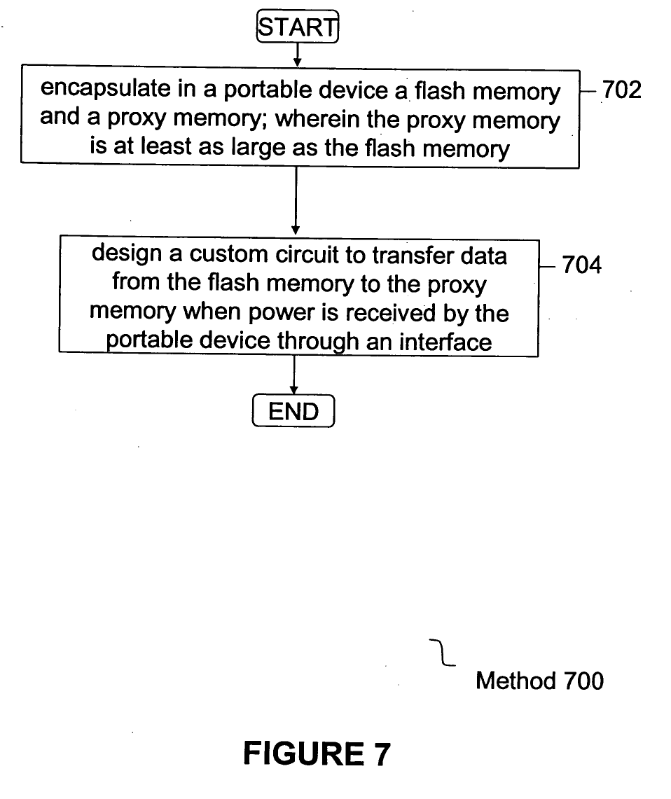

FIG. 7 is a process flow of a method 700 of manufacture of the executable-in-place solid-state device 150 of FIG. 1, according to one embodiment. In operation 702, a flash memory (e.g., the flash memory 202) and a proxy memory (e.g., the dynamic random access memory 204) is encapsulated in a portable device (e.g., a lanyard, a keyfob) in which the proxy memory (e.g., the dynamic random access memory 204) is at least as large as the flash memory (e.g., the flash memory 202). In operation 704, a custom circuit (e.g., an ASIC such as the custom circuit 200 as illustrated in FIG. 2) is designed to transfer data from the flash memory (e.g., the flash memory 202) to the proxy memory (e.g., the dynamic random access memory 204) when power is received by the portable device (e.g., the executable-in-place solid-state device 150) through an interface (e.g., the interface 208).

It should be noted that while the machine-readable medium 622 of FIG. 6 is shown in an embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, accessing. encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

Although the present embodiments has been described with reference to specific embodiments, it will be evident that various modifications and changes may be made to these embodiments without departing from the broader spirit and scope of the invention. For example, the various circuits described herein may be preformed and created using software (e.g., programming code, programming instructions, etc.) in addition to hardware circuitry (e.g., CMOS based logic circuitry).

For example, the custom circuit 200 that includes the prefetch circuit 302, the command arbitration circuit 300, the load register circuit 306, the output register circuit 308 and the power management circuit 304 may be embodied using transistors, logic gates, and electrical circuits (e.g., application specific integrated ASIC circuitry), as well as in software modules, such as for e.g. a custom module that includes a pre-fetch module, a command arbitration module, a load register module, a output register module and a power management module.

In addition, it will be appreciated that the various operations, processes, and methods disclosed herein may be embodied in a machine-readable medium and/or a machine accessible medium compatible with a data processing system (e.g., a computer system). Accordingly, the specification and drawings are to be regarded in an illustrative rather than a restrictive sense.

What is claimed is:

1. A solid-state device, including:
a flash memory coupled to a dynamic random access memory, the dynamic random access memory to store at least as much data as the flash memory; and
a logic circuit coupled to the flash memory and the dynamic random access memory to copy data from the flash memory to the dynamic random access memory on power up of a data processing system coupled to the solid-state device.

2. The solid-state device of claim 1, wherein the solid-state device is a portable device external to the data processing system.

3. The solid-state device of claim 2, wherein the portable device is at least one of a keyfob and a lanyard.

4. The solid-state device of claim 1, wherein the logic circuit is to minimize writes to the flash memory by using the dynamic access memory as a working memory during operation of the data processing system.

5. The solid-state device of claim 4, wherein the logic circuit is to block at least some sectors of at least one of the flash memory and the dynamic random access memory when the data processing system uses the working memory to conserve power usage of the solid-state device.

6. The solid-state device of claim 4, wherein the logic circuit is to transfer all data in the dynamic random access memory to the flash memory on power down of the data processing system.

7. The solid-state device of claim 1, wherein the solid-state device is packaged to withstand heat at least until 125 degrees Celsius, and has a mean time between failures of 3 million hours.

8. The solid-state device of claim 1, wherein the solid-state device is coupled to the data processing system through a USB connector.

9. The solid-state device of claim 1, wherein a liquid crystal display is to indicate that the solid-state device is operable when data of the flash memory is copied to the dynamic random access memory.

10. The solid-state device of claim 1, the application programs are executable directly from the solid-state device without customized optimization for the flash memory.

11. The solid-state device of claim 1, further including a driver of the data processing system to instruct the data processing system to boot up the data processing system from an operating system installed on the solid-state device.

12. The solid-state device of claim 11, wherein the driver is automatically loaded on the data processing system when the solid-state device is connected to the data processing system.

13. The solid-state device of claim 1, wherein the logic circuit is to copy sectors from the flash memory in an order based on a prior history of data access by the data processing system.

14. The solid-state device of claim 13, further including a capacitor to retain at least some data of the flash device in the dynamic random access memory upon power down of the data processing system.

15. A method including;
copying sectors of a flash memory of a solid-state device to a dynamic random access memory of the solid-state device when the solid-state device receives power through an interface;
manipulating sectors of the dynamic random access memory based on commands received from a data processing system; and
copying manipulated sectors of the dynamic random access memory back to the flash memory when power through the interface is no longer received.

16. The method of claim 15, wherein the dynamic random access memory holds at least as much data as the flash memory, and wherein the interface is at least one of a universal serial bus interface, a secure flash interface, a secure digital interface, and a compact flash interface.

17. The method of claim 15, wherein the solid-state device is a portable device external to the data processing system, and wherein the portable device is at least one of a keyfob and a lanyard.

18. The method of claim 15, wherein the sectors are copied to and from the flash memory in a predetermined order based on a prior history of access by the data processing system, and wherein the data processing system begins manipulating the data of the dynamic random access memory before all the sectors are copied from the flash memory to the dynamic random access memory.

19. The method of claim 18, wherein the manipulating includes at least one of a write, a read, a delete, and a modify function to at least one sector of the dynamic random access memory.

20. A machine readable method of a data processing system, including:
providing power to an executable-in-place portable flash device external to the data processing system through a USB interface;
redirecting a boot process of the data processing system to the flash device based on a driver installed in a storage device of the data processing system;
executing at least one application on a proxy memory of the executable-in-place portable flash device, wherein the proxy memory is at least as large as a flash memory of the executable-in-place portable flash device and contains a mirror image of the data of the flash memory.
